(19) United States
(12) Patent Application Publication
(10) Pub. No.: US 2014/0182306 A1
(43) Pub. Date: Jul. 3, 2014

(54) FILTER FOR AIRCRAFT APU SYSTEM

(71) Applicant: UNITED TECHNOLOGIES CORPORATION, Hartford, CT (US)

(72) Inventor: Lamont Larry Castagnera, El Cajon, CA (US)

(21) Appl. No.: 13/730,819

(22) Filed: Dec. 28, 2012

(51) Int. Cl. F02C 9/00; F28D 7/00

(52) U.S. Cl. CPC F02C 9/00; F28D 7/00
USPC 60/784; 165/185

(57) ABSTRACT

An auxiliary power unit (APU) system comprises an auxiliary power unit (APU) mounted in a compartment of an aircraft. A first air inlet conduit directs air to a first component disposed in the compartment. A first dry filter element is disposed within the first air inlet conduit, and has a substantially uniform pore size.

### BACKGROUND

The described subject matter relates generally to an aircraft auxiliary power unit (APU) system, and more specifically to prevention of corrosion of APU system components.

Corrosion of APU system components in aircraft can be initiated by repeated exposure to airborne particulates and contaminants, and accelerated by subsequent cleaning. While some aircraft APU systems are unfiltered to maintain a predictable air flow rate, unfiltered air can sometimes contain dangerous levels of these contaminants. Many traditional filter materials can quickly become clogged under wet and dirty operating conditions, reducing effective pore size of the filter, restricting the required airflow before the filter(s) can be cleaned or replaced. Such filter materials are also prone to the individual fibers breaking down, which also prematurely restricts air flow to the APU compartment and system components.

### SUMMARY

An auxiliary power unit (APU) system comprises an auxiliary power unit (APU) mounted in a compartment of an aircraft. A first air inlet conduit directs air to a first component disposed in the compartment. A first dry filter element is disposed within the first air inlet conduit, and has a substantially uniform pore size.

An oil cooler assembly comprises a heat exchanger unit, a cooling air inlet, and a dry filter element. The heat exchanger unit includes an oil path configured to receive oil from an aircraft auxiliary power unit (APU) system, and a cooling air path in heat transfer relationship with the oil path. The cooling air inlet directs cooling air through the filter element to the heat exchanger cooling air path. The dry filter element has a substantially uniform pore size.

A component for an aircraft auxiliary power unit (APU) system comprises a line replaceable unit (LRU) adapted for installation into the APU system; and a filter bonnet. The filter bonnet includes a dry filter element secured over at least one surface of the LRU. The dry filter element has a substantially uniform pore size.

### BRIEF DESCRIPTION OF THE DRAWINGS

FIG. 1 schematically depicts an aircraft APU system and compartment.

FIG. 2 shows an APU oil cooler provided with an inline air filter.

### DETAILED DESCRIPTION

Inlet and cooling air provided to aircraft APU systems is often unfiltered because the relative infrequency of system operation can allow the components to survive the occasional intrusion of particulates and contaminants. This allows for a consistent and predictable supply of inlet or cooling air without the risk of reduced pressure drop and flow rate across a clogged or dirty filter. However, certain aircraft APU components containing copper-based braze compositions, such as oil coolers and other line replaceable units (LRU's), have been found to experience rapid corrosion. The corrosion can be initiated and propagated by repeated exposure to wet and dirty operating environments. Increased reliance on APU systems for electrical power, including engine starting and ground power, exposes APU components to large airborne particulates and aqueous contaminants. With the expansion of regular commercial airline service, and maintenance facilities stationed in more remote locations, aircraft APU systems are being exposed more often to these and other harmful operating conditions. And while post-exposure cleaning can remove corrosion, the cleaning process itself can further weaken the component and shorten repair intervals.

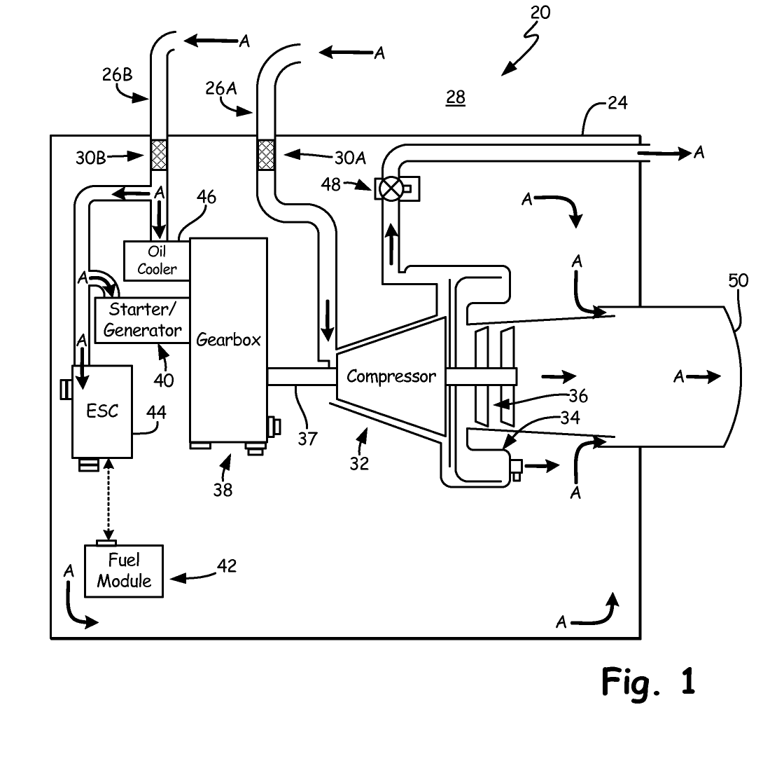

FIG. 1 shows aircraft auxiliary power unit (APU) system 20, APU 22, APU compartment 24, first air inlet conduit 26A, second air inlet conduit 26B, aircraft exterior 28, first dry filter element 30A, second dry filter element 30B, compressor 32, combustor 34, dual-stage turbine 36, shaft 37, gearbox 38, starter-generator 40, fuel module 42, electric starter controller (ESC) 44, oil cooler 46, valve 48, and exhaust port 50. Air flow is shown as solid arrows A.

In aircraft APU system 20, APU 22 is mounted in APU compartment 24 along with a number of ancillary components. APU 22, in one example, can be a gas turbine driving one or more electrical and/or hydraulic generators. APU compartment 24 is in a section of the aircraft such as, but not limited to, the tail region, landing gear compartment, or any other suitable area for safely and efficiently operating APU 22.

First and second air inlet conduits 26A, 26B can provide inlet and/or cooling air generally to compartment 24, or may be configured to direct air to individual components of APU system 20, including APU 22. First and second air inlet conduits 26A, 26B are shown to be in fluid communication with aircraft exterior 28. Alternatively, one or more air inlet conduits may draw air from inside compartment 24 or from another suitable air source, in order to direct the air to one or more APU components in compartment 24. In this example, first air inlet conduit directs air from exterior 28 to a first component, here APU 22. Second air inlet conduit 26B directs cooling air from exterior 28 to at least a second component also in compartment 24. A portion of the cooling and/or inlet air from air inlet conduits 26A, 26B may be directed to other ancillary components as well.

First and second dry filter elements 30A, 30B are disposed within respective air inlet conduits 26A, 26B to filter inlet and/or cooling air directed to first and second APU components. In certain embodiments, first and second dry filter elements 30A, 30B are external to, but fluidly connected to first and second air inlet conduits 26A, 26B. In this example embodiment, first air inlet conduit 26A provides ambient air for APU 22, which is rammed or drawn in through first air inlet conduit 26A, then compressed by APU compressor 32. Ambient air can be drawn through first inlet 26A and compressed by compressor 32 before being combined with fuel and delivered to combustor 34. Expansion of combustion products provides a working gas that is converted to mechanical energy by turbine 36. In this non-limiting example, turbine 36 captures and communicates mechanical energy by way of shaft 37, which rotates compressor 32 and gearbox 38 for distributing power to loads such as starter-generator 40.

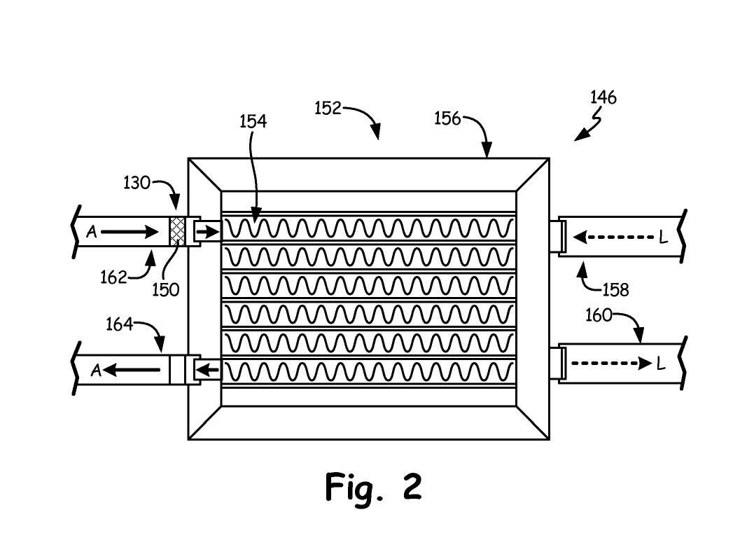

Second inlet conduit 26B in this example, is also in fluid communication with aircraft exterior 28 to direct cooling air to APU system 20. The cooling air may be directed either generally to compartment 24, or more specifically to one or more of the ancillary components. Here, these include gearbox 38, starter-generator 40, fuel module 42, electric starter controller (ESC) 44, oil cooler 46, and/or valve 48. Electric starter controller 44 regulates compressor 32, fuel module 42, and/or starter-generator 40 depending on the operational mode of APU 22. Oil cooler 46 can include one or more heat exchanger units configured to regulate the operating temperature of lubricant used in APU system 20 as described in more detail with regard to FIG. 2 below. One or more valves 48 can be disposed in and around APU compartment 24 to regulate the flows to and from the various components. Example types of valves 48 include flow control valves, surge valves and bleed valves. APU 22 is vented to aircraft exterior 28 via exhaust duct 50.

Inlet air and cooling air enters through first and second air inlet conduits 26A, 26B, and can be passed respectively through first and second in-line dry filter elements 30A, 30B before being directed to the corresponding APU component(s). In certain embodiments, dry filter elements 30A, 30B can be provided with a filter fabric having substantially uniform pore size to selectively block ingestion of larger particles and aqueous contaminants. The pore size allows smaller, less harmful particles to pass generally unimpeded so that a consistent pressure drop and air flow A can be maintained across filter elements 30A, 30B.

Many filters can quickly become clogged particularly under wet and dirty operating conditions, which can immediately reduce pore size and the resulting air flow to the APU components before the next available opportunity for filter cleaning and/or replacement. Thus dry filter elements 30A, 30B can have a substantially uniform pore size to reduce exposure of APU system 20 to liquid contaminants and larger particulates above a certain size most likely to initiate corrosion.

Corrosion can be initiated by pitting from large particulates reaching the components. Larger corrosion-inducing particulates lose momentum after striking dry filter elements 30A, 30B, and many of them fall away before they can clog the inlet or damage APU system 20. Propagation of any corrosion can be slowed by reducing contact with aqueous contaminants. Dry filter elements 30A, 30B can also wick away many of these aqueous contaminants such as those found in wet and dirty operating environments, as well as those ingested during ground operations (e.g., salt water and glycol-based deicing fluids).

In certain embodiments, dry filter elements 30A, 30B can include respective first and second pluralities of water-repellent monofilament fibers woven into respective first and second filter fabrics. Such fibers are dirt repellent and easy to clean. The filter fabrics may be secured directly in the air inlet conduit, or as part of separate apparatus in communication with the air inlet conduit using suitable fittings. To assist with removal of wicked-away liquids, one or both inlet ducts 26A, 26B can be provided with a drain (not shown) proximate upstream sides thereof.

Other filters have one or more characteristics making them unsuitable for use in APU systems or compartments. In one example, oil and electrostatic treatments are known to increase particle pickup, but this causes very small particles to adhere and accumulate in and around the pores. This reduces the substantially uniform size of the pores during operation, and reduces the resulting airflow through the filter.

Since small airborne particulates carry a relatively low risk of initiating corrosion under these circumstances, they can be allowed to pass by leaving dry filter elements 30A, 30B free of oil and electrostatic treatments. Further, it will be understood that small amounts of oil may be ingested in certain operating environments, and will cling to the fibers during operation. However, this will not unduly hinder filter performance or reduce cleaning and maintenance intervals.

Many dry filters are made from materials with inconsistent pore size and/or insufficient water repellency so that they become clogged too quickly for use in APU applications. Many of these filter materials have fibers that break down on exposure to common airborne contaminants, which can also contribute to clogging of the pores and reduce required air flow. While water repellency of certain filter fabrics can be supplemented by various spray-on compounds, these compounds adhere to the exterior of the fibers and also reduce pore size.

To help maintain strength and shape of the individual fibers over time, the plurality of monofilament fibers can be extruded or dry-pulled so as to form an effective single-crystal polymer structure. To this end, at least some of the plurality of monofilament fibers can comprise an extruded polyester composition. In certain embodiments, at least some of the plurality of monofilament polyester fibers comprise poly(ethylene terephthalate) (PET). In yet certain of these embodiments, substantially all of the plurality of monofilament polyester fibers comprise poly(ethylene terephthalate) (PET).

As noted above, treatments to enhance water repellency of filters usually rely on compounds which adhere to the outside of the fibers, reducing the uniformity and the overall pore size of the filter. To prevent this, the plurality of monofilament polymer fibers can be adapted to be individually water repellent prior to being woven into the finished fabric. While spray-coating a finished fabric with a water repellent composition is simpler and generally less expensive, the spray-coating treatment reduces uniformity of the pores. However, treating individual monofilament fibers, for example as part of the fiber-making process, maintains uniformity of the desired pore size. There is then no need for reapplication of water repellent coatings to extend the useful life of the fabric. Non-limiting examples of suitable PET fibers and fabrics with individually water-repellent fibers are available commercially from Outerwears, Inc. of Schoolcraft, Mich.

To optimize airflow to APU system 20, dry filter elements 30A, 30B can have and maintain an effective pore size of between about 0.0025 inches (about 0.06 mm) and about 0.010 inches (about 0.25 mm). In certain embodiments, dry filter elements 30A, 30B can have and maintain an effective pore size of between about 0.0035 inches (about 0.09 mm) and about 0.005 inches (about 0.25 mm). In the examples given, dry filter elements 30A, 30B are effective at removing about 90% of particles equal to or larger than the effective pore size.

FIG. 1 shows first air inlet conduit 26A as having air drawn in by compressor 32, while second air inlet conduit 26B is shown as a passive air inlet, such as an eductor. As is well known in the art, an eductor relies on exhaust gas to provide a pressure gradient to draw in air from aircraft exterior 28. However, it will be appreciated that dry filter elements 30A, 30B can be readily adapted to other types of APU air induction systems as well.

In the example shown, second air inlet conduit 26B is a single inlet with several branches directed to provide cooling air for individual ancillary APU components, including starter-generator 40 and oil cooler 46. Starter-generator 40 may alternatively include one or more air-cooled electric machines such as a separate electric starter and/or generator. In certain embodiments, oil cooler 46 is an air/oil heat exchanger, an example of which is shown in FIG. 2. Thus, it will also be appreciated that APU system 20 will vary according to individual installations. For example, certain alternative embodiments may include first air inlet conduit 26A as a cooling air conduit, while second air inlet conduit 26B provides working gas to APU 22. Other embodiments may only have one air inlet conduit 26, or there may be more than two air inlet conduits 26, one or more of which includes a dry filter element as described above.

In addition to placing a filter element in an air inlet conduit, one or more individual components for APU system 20 can include corrosion protection by way securing a dry filter element thereto. In certain embodiments, a component adapted for installation into the APU system includes a line replaceable unit (LRU) having a filter bonnet (not shown) secured over at least one surface of the LRU. The filter bonnet will vary according to the particular geometry of the LRU, but will include at least one dry filter element having a substantially uniform pore size. The LRU can be one of any number of components suitable for use in an APU system or compartment, such as those shown in FIG. 1 (e.g., starter/generator 40, fuel control module 42, ESC 44, and valve 48) Other examples include a separate starter and/or generator, as well as any number of sensors.

The dry filter element can include one or more of the characteristics described with respect to example filter elements 30A, 30B. For example, the dry filter element can include a plurality of water-repellent monofilament fibers woven into a filter fabric. Some or substantially all of the plurality of monofilament fibers can optionally comprise poly(ethylene terephthalate) or other polyester compounds, and can optionally be adapted to be individually water repellent prior to being woven into the filter fabric.

FIG. 2 includes filter assembly 130, APU oil cooler assembly 146, heat exchanger unit 152, first fluid path 154, second fluid path 156, oil inlet 158, oil outlet 160, air inlet 162, and air outlet 164. Air flow is shown as solid arrows A, and oil flow is shown as dashed arrows L.

FIG. 2 shows an embodiment in which dry filter assembly 130 is disposed in line with APU oil cooler assembly 146. APU oil cooler assembly 146 can include heat exchanger unit 152 with first fluid path 154 in heat transfer relationship with second fluid path 156. In this example, heat exchanger unit 152 is an air-oil heat exchanger, where first fluid path 154 is a cooling air path. Second fluid path 156 is an oil path with inlet 158 and outlet 160 disposed at the rear of heat exchanger unit 152. Air-oil heat exchanger 152, which in this example is a plate-and-fin type unit, receives and cools oil from one or more components of an aircraft APU system, such as APU 22 (shown in FIG. 1). Hot oil from APU system 20 enters via inlet 158 and exits at oil outlet 160, after being cooled by cooling air entering inlet 162. The air exits at air outlet 164 after being warmed in the cooling air path by heat exchange with oil. Cooling air may be provided from one or more sources including, for example, APU compartment 24 and/or aircraft exterior 28 (shown in FIG. 1).

With cooling air path 154 in heat transfer relationship with oil path 156, the oil tubes and frame of heat exchanger unit 152 are susceptible to corrosion from particles and aqueous contaminants entering cooling air path 154, particularly those prevalent in wet and dirty operating environments. Dry filter assembly 130 can be disposed in cooling air path 154 upstream of oil path 156, and can include a water-repellent, oil-free dry filter element with a filter fabric similar to that described with respect to FIG. 1.

As noted in the previous example, dry filter element 130 can include a fabric comprising a plurality of water-repellent monofilament fibers. The plurality of fibers can be woven, and some or all of which can comprise extruded or dry-pulled monofilament polyester fibers such as poly(ethylene terephthalate) (PET). The monofilament fibers can be treated at the mill to be individually water repellent to alleviate the need for spraying hydrophobic coatings onto the finished woven filter fabric. The woven filter fabric can be oil-free and remain electrostatically uncharged so as to prevent excess accumulation and agglomeration of particulates and moisture from blocking the filter pores. The water-repellent dry filter element 150 can include and maintain an effective pore size of between about 0.0035 inches (about 0.09 mm) and about 0.005 inches (about 0.25 mm).

It can be seen that filter assembly 130 is secured in air inlet 162 just upstream of the air-oil heat exchanger unit 152, so that cooling air in path 152 passes through dry filter element 150 before crossing oil path 154. It will be recognized that additionally or alternatively, filter assembly 130 can be mounted inside the air path of heat exchanger unit 152. Optionally, oil cooler assembly 146 is fed by a dedicated cooling air inlet conduit in fluid communication with the exterior of the aircraft. An example of this is shown in FIG. 1.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An auxiliary power unit (APU) system comprising:
an auxiliary power unit (APU) mounted in a compartment of an aircraft;
a first air inlet conduit directing air to a first component disposed in the compartment; and
a first dry filter element disposed within the first air inlet conduit, the dry filter element having a substantially uniform pore size.

2. The system of claim 1, wherein the first dry filter element comprises a first plurality of water-repellent monofilament fibers woven into a first filter fabric.

3. The system of claim 2, wherein substantially all of the first plurality of water-repellent monofilament fibers are free of an electrostatic treatment.

4. The system of claim 2, wherein substantially all of the first plurality of water-repellent monofilament fibers comprise poly(ethylene terephthalate), and wherein substantially all of the first plurality of monofilament fibers are adapted to be individually water repellent prior to being woven into the first filter fabric.

5. The system of claim 1, wherein the dry filter element has an effective pore size of between about 0.0025 inches (about 0.06 mm) and about 0.010 inches (about 0.25 mm).

6. The system of claim 1, further comprising:
a second air inlet conduit directing air to a second component disposed in the compartment; and
a second dry filter element disposed within the second air inlet conduit, the second dry filter element having a substantially uniform pore size

7. The system of claim 6, wherein the second dry filter element comprises a second plurality of water-repellent monofilament fibers woven into a second dry filter fabric, and wherein the second dry filter element has an effective pore size of between about 0.0025 inches (about 0.06 mm) and about 0.010 inches (about 0.25 mm).

8. The system of claim 6, wherein at least one of the first air inlet conduit and the second air inlet conduit provides fluid communication between the exterior of the aircraft and at least one ancillary APU component disposed within the aircraft compartment.

9. The system of claim 8, wherein the at least one ancillary APU component comprises an oil cooler.

10. The system of claim 8, wherein the at least one ancillary APU component comprises an air-cooled electric machine.

11. An oil cooler assembly comprising:
a heat exchanger unit including an oil path configured to receive oil from an aircraft auxiliary power unit (APU) system, and a cooling air path in heat transfer relationship with the oil path;
a cooling air inlet directing cooling air to the heat exchanger cooling air path; and
a dry filter element disposed proximate the cooling air inlet for filtering cooling air directed toward the heat exchanger cooling air path, the dry filter element having a substantially uniform pore size.

12. The assembly of claim 11, wherein the dry filter element comprises a plurality of water-repellent monofilament fibers woven into a filter fabric.

13. The assembly of claim 12, wherein substantially all of the plurality of water-repellent monofilament fibers comprise poly(ethylene terephthalate), and are adapted to be individually water repellent prior to being woven into the filter fabric.

14. The assembly of claim 12, wherein substantially all of the plurality of water-repellent monofilament fibers are free of an electrostatic treatment.

15. The assembly of claim 11, wherein the dry filter element has an effective pore size of between about 0.0035 inches (about 0.09 mm) and about 0.005 inches (about 0.25 mm).

16. The assembly of claim 11, wherein the dry filter element is secured to the heat exchanger unit.

17. The assembly of claim 11, wherein the dry filter element is disposed within a dedicated cooling air conduit in fluid communication with an exterior of the aircraft.

18. A component for an aircraft auxiliary power unit (APU) system, the component comprising:
a line replaceable unit (LRU) adapted for installation into the APU system; and
a filter bonnet including a dry filter element secured over at least one surface of the LRU, the dry filter element having a substantially uniform pore size.

19. The component of claim 18, wherein the dry filter element includes a plurality of water-repellent monofilament fibers woven into a filter fabric, and wherein substantially all of the plurality of monofilament fibers comprise poly(ethylene terephthalate).

20. The assembly of claim 19, wherein substantially all of the plurality of water-repellent monofilament fibers are adapted to be individually water repellent prior to being woven into the filter fabric.

21. The assembly of claim 18, wherein the dry filter element has an effective pore size of between about 0.0035 inches (about 0.09 mm) and about 0.005 inches (about 0.25 mm).

22. The assembly of claim 18, wherein the LRU is selected from one of: a bleed valve, a surge valve, a fuel controller, a starter, a generator, and a sensor.
